(19) United States
(12) Patent Application Publication
(10) Pub. No.: US 2025/0087716 A1
(43) Pub. Date: Mar. 13, 2025

(54) FUEL CELL VEHICLE THERMAL SYSTEM

(71) Applicant: FCA US LLC, Auburn Hills, MI (US)

(72) Inventor: Matthew T. Bartlett, Northville, MI (US)

(21) Appl. No.: 18/466,363

(22) Filed: Sep. 13, 2023

(51) Int. Cl. H01M 8/0267; B60L 50/72; B60L 58/33; H01M 8/04007; H01M 8/04029

(52) U.S. Cl. CPC H01M 8/0267; B60L 50/72; B60L 58/33; H01M 8/04029; H01M 8/04074

(57) ABSTRACT

A thermal management system for a vehicle having a fuel cell stack includes a condenser fluidly coupled to the fuel cell stack to receive a flow of water/air exhaust therefrom, and a liquid-gas separator fluidly coupled to the condenser to receive the flow of water/air exhaust therefrom. A storage reservoir includes an inlet to receive separated liquid water from the liquid-gas separator. One or more spray nozzles are fluidly coupled to the storage reservoir supply outlet to receive a flow of liquid water therefrom, and a coolant circuit is configured to circulate a coolant to the fuel cell stack for cooling thereof, the coolant circuit including a radiator configured to cool the coolant. The one or more spray nozzles are configured to selectively spray the liquid water onto the radiator to increase cooling of the coolant and improve performance of the fuel cell stack.

### FIELD

The present application relates generally to fuel cell vehicles and, more particularly, to a fuel cell vehicle with a water cooled thermal system.

### BACKGROUND

Some vehicles include proton exchange membrane (PEM) fuel cells for motive power. Such PEM fuel cells have the advantage of rejecting less total heat than internal combustion engines. However, the amount of heat rejected to the cooling system is higher and such cooling systems often have a reduced maximum allowable coolant temperature. Moreover, when PEM fuel cells are installed in vehicles designed for internal combustion engines, there is often insufficient space to install large enough radiators and fans to provide sufficient heat rejection capability for desired vehicle performance, such as towing a trailer on steep grades. As such, cooling system performance potentially limits vehicle performance. Accordingly, while such fuel cell systems work for their intended purpose, there is a desire for improvement in the relevant art.

### SUMMARY

In accordance with one example aspect of the invention, a thermal management system for a vehicle having a fuel cell stack is provided. In one example, the thermal management system includes a condenser fluidly coupled to the fuel cell stack to receive a flow of water/air exhaust therefrom, and a liquid-gas separator fluidly coupled to the condenser to receive the flow of water/air exhaust therefrom, the liquid-gas separator including a first outlet to direct separated gas to an exhaust line, and a second outlet for separated liquid water. A storage reservoir includes an inlet to receive the separated liquid water from the second outlet of the liquid-gas separator, and a supply outlet for the liquid water. One or more spray nozzles are fluidly coupled to the storage reservoir supply outlet to receive a flow of liquid water therefrom, and a coolant circuit is configured to circulate a coolant to the fuel cell stack for cooling thereof, the coolant circuit including a radiator configured to cool the coolant. The one or more spray nozzles are configured to selectively spray the liquid water onto the radiator to increase cooling of the coolant and improve performance of the fuel cell stack.

In addition to the foregoing, the described thermal management system may include one or more of the following features: a membrane humidifier configured to receive the flow of water/air exhaust from the fuel cell stack and humidify a flow of air into the fuel cell stack before supplying the water/air exhaust flow to the condenser; a three-way valve disposed upstream of the condenser and configured to selectively direct the flow of water/air exhaust to the condenser or the exhaust line; a back pressure control valve disposed upstream of the three-way valve; and a back pressure control valve disposed in the exhaust line downstream of the three-way valve.

In addition to the foregoing, the described thermal management system may include one or more of the following features: a three-way valve disposed upstream of the condenser and configured to selectively direct the flow of water/air exhaust to the condenser or the separator; and an expander operably coupled to a compressor and an electric motor, wherein the expander is configured to expand a gaseous portion of the water/air exhaust from the fuel cell stack upstream of the three-way valve, wherein the compressor is configured to compress ambient air before supplying the compressed air to the fuel cell stack, and wherein the electric motor is configured to generate electricity due to rotation of the expander.

In addition to the foregoing, the described thermal management system may include one or more of the following features: wherein the liquid-gas separator is a pressurized accumulator vessel; wherein the liquid-gas separator includes a first sensor configured to measure a liquid level in the liquid-gas separator, and wherein the storage reservoir includes a second sensor configured to measure a liquid level in the storage reservoir; a pump disposed between the storage reservoir supply outlet and the one or more spray nozzles, and a controller in signal communication with the second sensor and the pump, the controller configured to control the flow of liquid water to the one or more spray nozzles based on the measured liquid level in the liquid-gas separator; and wherein when the measured liquid level meets or exceeds a predetermined full threshold, the controller commands the pump to provide a maximum flow rate to the one or more spray nozzles.

In addition to the foregoing, the described thermal management system may include one or more of the following features: a pump disposed between the separator second outlet and the storage reservoir, and a controller is signal communication with the first sensor and the pump, the controller configured to control the flow of liquid water to the storage reservoir based on the measure liquid level in the liquid-gas separator; and wherein the controller is configured to operate the thermal management system in a Performance Mode where, based on GPS map-based route planning data and ambient temperature, the controller sets an RPM of the pump to ensure liquid water is available to the one or more spray nozzles during a predicted high load fuel cell operating event.

In addition to the foregoing, the described thermal management system may include one or more of the following features: wherein the controller is configured to operate the thermal management system in a Shut-Down Mode where the controller is configured to drain the liquid-gas separator and/or the storage reservoir if the ambient temperature is less than a predetermined threshold to thereby prevent freezing of the liquid water in the thermal management system; and wherein the controller is configured to operate the thermal management system in an Eco-Mode where, when the sensor indicates the storage reservoir is partially full, the controller is configured to supply liquid water to the one or more spray nozzles while reserving a portion of the liquid water to increase the water level in the storage reservoir for a predicted high-demand portion of a drive cycle.

In addition to the foregoing, the described thermal management system may include one or more of the following features: wherein the condenser is a tube and fin heat exchanger with an electric fan configured to cool the water/air exhaust via heat exchange with ram air flow and/or airflow generated by the electric fan; wherein the condenser is a tube heat exchanger configured to cool the water/air exhaust via heat exchange with ram air flow; wherein the condenser is a liquid cooled heat exchanger thermally coupled to a second coolant circuit of the vehicle; and a drain valve disposed between the storage reservoir supply outlet and the one or more spray nozzles, the drain valve configured to drain liquid water from the thermal management system to prevent damage thereof.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example thermal management system for a fuel cell vehicle, in accordance with the principles of the present application;

FIG. 2 is a schematic illustration of an example liquid-gas separator shown in FIG. 1, in accordance with the principles of the present application; and

FIG. 3 is a schematic illustration of another example thermal management system for a fuel cell vehicle, in accordance with the principles of the present application.

### DETAILED DESCRIPTION

According to the principles of the present application, systems and methods are described for a thermal management system for a fuel cell powered electric vehicle. The thermal management system is configured to capture water created in a hydrogen fuel cell stack (FCS), and subsequently spray the product water onto a high temperature radiator for cooling of the thermal system. The thermal system also includes a condenser and a hybrid condenser bypass valve to manage the cathode fluid stream flow between the cathode exhaust and the condenser. A liquid/gas separator with liquid level detection retains liquid water and direct the gas outside of the vehicle. A transfer pump is configured to transfer liquid water from separator into a large storage volume equipped with a vent and liquid level detection. A spray pump it utilized to pump the stored water to a number of spray nozzles that release the water onto the high temperature radiator. A drain valve is used to drain liquid water from portions of the system if the ambient temperature is low enough to cause freezing of the liquid water.

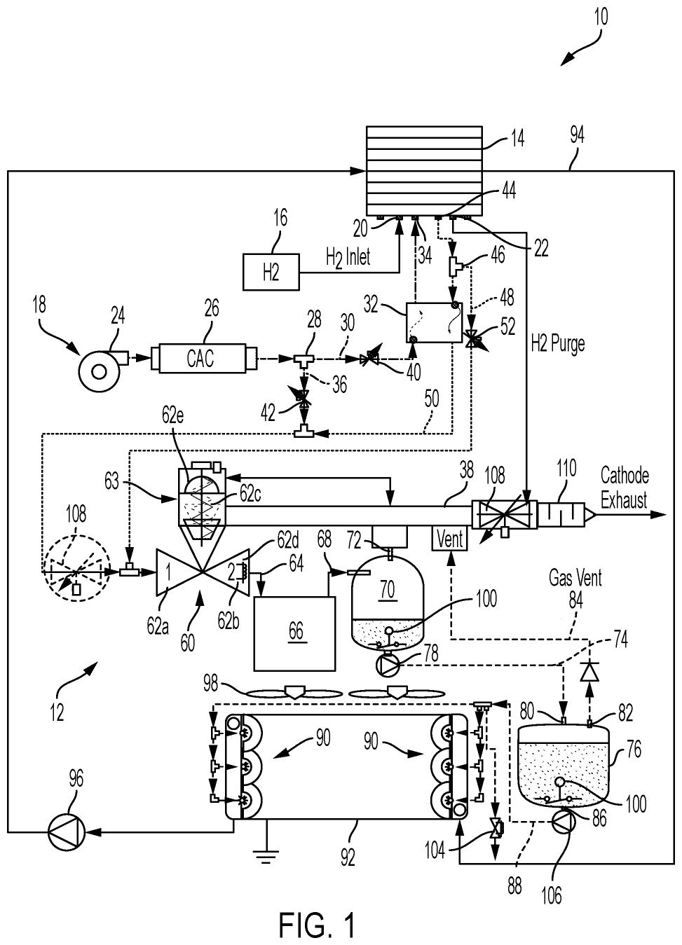

With reference now to FIG. 1, a vehicle fuel cell system 10 with an associated thermal management system 12 is illustrated in accordance with the principles of the present disclosure. The vehicle fuel cell system 10 generally includes a fuel cell stack 14, a hydrogen fuel source 16, and an oxygen fuel source 18. In the example embodiment, the fuel cell stack 14 is a proton exchange membrane (PEM) fuel cell stack formed by stacking a plurality of fuel cells, which are configured to generate electricity by electrochemical reactions of a fuel gas (e.g., hydrogen) and an oxygen containing gas (e.g., ambient air). As is well known in the art, each fuel cell includes an electrolyte membrane disposed between an anode and a cathode. It will be appreciated, however, that the thermal management system 12 described herein may be utilized with various other types of fuel cell systems.

The hydrogen fuel source 16 is fluidly coupled to the fuel cell stack 14 at an inlet 20, and unused hydrogen fuel is directed through an outlet 22. The oxygen fuel source 18 is provided by an air compressor 24, which compresses ambient air. The compressed and heated air is subsequently directed through a heat exchanger 26 (e.g., charge air cooler) for cooling thereof. The cooled and compressed air is then directed to a junction 28, where a first portion of compressed air is supplied through a conduit 30 to a membrane humidifier 32 before entering the fuel cell stack 14 via an inlet 34. A second portion of the compressed air is directed through a conduit 36 to an exhaust conduit 50. Valves 40, 42 are utilized to control the flow of compressed air through conduits 30, 36.

Once in the fuel cell stack 14, the compressed air reacts with the hydrogen fuel, which generates electricity and water byproduct (water product). The product water and unused air are then directed through an outlet 44 to a junction 46. A first portion of the water/air exhaust is directed through a conduit 48 to a downstream location in the exhaust conduit 50. A second portion of the water/air exhaust is directed via conduit 50 to the membrane humidifier 32 where water vapor from the exhaust gas is transferred to the compressed air supplied to inlet 34 to maintain an optimal hydration level of the electrolyte membrane. The water/air exhaust is then directed to the integrated thermal management system 12. A valve 52 is utilized to control the flow of the water/air exhaust through conduit 48. In one example, valve 52 is opened when the FCS 14 is shut down in cold weather and the air compressor 24 is utilized to evacuate the hydrogen and oxygen lines to facilitate preventing freezing damage.

In the example embodiment, the thermal management system 12 is configured to utilize the water/air exhaust from the fuel cell stack 14 to cool the fuel cell stack 14 and maintain an optimal temperature thereof. The thermal management system 12 includes a three-way valve 60, which in the example implementation, is a hybrid condenser bypass valve with an inlet port 62a, a first outlet port 62b, and a second outlet port 62c. The three-way valve 60 is configured to direct the received water/air exhaust either through a condenser bypass passage 63 to an exhaust line 38, or through a conduit 64 to a condenser 66. The three-way valve 60 functions as a condenser bypass for vehicle operating conditions where the product water in the cathode exhaust stream could potentially freeze and block conduit 64. In on example, the three-way valve 60 and exhaust line 38 are integrated into a single housing.

In the example implementation, the inlet port 62a is configured to receive the water/air exhaust from conduit 50. The first outlet port 62b includes a solenoid 62d to selectively open or close the outlet port 62b. The OFF (closed) state is utilized when there is a risk of freezing in the system or when other parts of the system (e.g., a reservoir) become full. The second outlet port 62c is a pressure compensated pressure regulator, which operates to bypass the condenser 66 in a first scenario when the first outlet port 62b is closed, or in a second scenario when the first outlet port 62b is open and the condenser 66 is operating normally and a subsequent increase in fuel cell power is experienced.

In one example of the first scenario, when the ambient temperature falls below a predetermined threshold (e.g., 10° C.), the three-way valve 60 then directs the received water/air exhaust to the exhaust line 38. In one example of the second scenario, the water/air exhaust mass flow rate may be increased in the condenser 66 and the conversion of vapor to liquid ceases because the condenser 66 has a limited ability to reject heat. In this case, a spring and compensation pressure from the downstream location act on a diaphragm 62e to regulate mass flow through the condenser 66 by passing a variable amount of the water/air exhaust through the condenser bypass passage 63. This allows liquid condensation over a wide range of FCS power operation when the condenser 66 is the system limitation.

The condenser 66 is configured to condense water vapor present in the cathode exhaust stream. In one embodiment, the condenser 66 is an air cooled heat exchanger configured to cool the cathode exhaust stream by passing ambient air over the heat exchanger via ram air and/or a fan (not shown). In another embodiment, condenser 66 is an air cooled cathode exhaust tube condenser configured to cool the cathode exhaust stream by passing ambient air over the cathode exhaust tube. In yet another embodiment, condenser 66 is a liquid cooled heat exchanger thermally coupled to an existing cooling system of the vehicle, for example, that cools traction batteries.

The water/air exhaust stream is at least partially condensed in condenser 66 and subsequently directed via a conduit 68 to a pressurized, non-vented liquid-gas separator 70. In the example embodiment, the separator 70 is configured to separate the gas and liquid received from conduit 68. The separated gas is directed to the exhaust line 38 via a conduit 72. The separator 70 also functions as a liquid reservoir and is configured to direct the separated liquid product water through a conduit 74 to a larger storage reservoir 76 (second reservoir). A pump 78 may be utilized to supply the liquid product water to an inlet 80 of the storage reservoir 76.

In the example embodiment, the storage reservoir 76 is configured to further separate any gas and liquid received from conduit 74. The separated gas is directed through an outlet 82 to the exhaust line 38 via a conduit 84. The storage reservoir 76 is configured to store the liquid product water for selective flow through a second outlet 86 to a supply conduit 88. A plurality of spray nozzles 90 are fluidly coupled to the supply conduit 88 and configured to selectively spray the product water onto a high-temperature radiator 92, which is thermally coupled to the fuel cell stack 14 for cooling thereof via a coolant circuit 94 and pump 96.

The product water sprayed onto the radiator 92 at least partially evaporates against the relatively hot radiator coolant, thereby increasing heat dissipation and reducing the radiator coolant temperature further than can be accomplished by air alone. The radiator 92 may be disposed between an A/C condenser (not shown) and one or more fans 98 to further improve evaporation, cooling, and airflow across the radiator 92.

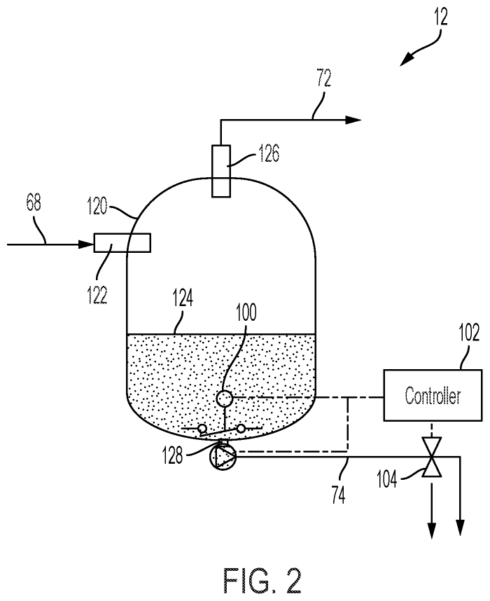

In some embodiments, shown in FIG. 1, the separator 70 and storage reservoir 76 each include a sensor 100 configured to measure a liquid level in the reservoir. The sensor 100 may be in signal communication with a controller 102 (e.g., fuel cell stack controller, FIG. 2). A drain valve 104 may be fluidly coupled to the supply conduit 88 and configured to drain product water when the vehicle is not operating and ambient temperature conditions could cause the product water to freeze and potentially damage system components. Additionally, a pump 106 may be located on the supply conduit 88 to increase pressure and ensure adequate flow of product water from the storage reservoir 76 to the spray nozzles 90.

Further, as shown in FIG. 1, a back pressure control valve 108 and a silencer/diluter 110 may be disposed on the exhaust line 38. In the example embodiment, the back pressure control valve 108 is located downstream of the gas vents of separator 70 and storage reservoir 76 and upstream the silencer/diluter 110. In an alternative arrangement (shown in phantom), back pressure control valve 108 is instead located upstream of the bypass valve inlet port 62a.

With continued reference to FIG. 2, the liquid-gas separator 70 will be described in more detail. In the example embodiment, the separator 70 generally includes an accumulator vessel or housing 120 having an inlet port 122, a filter 124, a first outlet port 126, and a second outlet port 128. The inlet port 122 is configured to receive a mixture of gas/liquid water from the condenser 66. The filter 124 is configured to capture entrained liquid water particles from the gas flow leading to the first outlet port 126. The filter 124 may be, for example, an internal screen, fiber, or foam pad. The first outlet port 126 is configured to direct separated gas to the exhaust line 38, and the second outlet port 128 is configured to direct separated liquid water product to the storage reservoir 76.

The controller 102 is configured to selectively drain liquid through the drain valve 104, which may be, for example, an electric solenoid valve or a bi-metal spring actuated drain valve. Further, when the controller 102 detects the liquid level in the separator 70 and/or storage reservoir 76 has exceeded a predetermined level (e.g., based on signals from sensors 100), the controller 102 may open drain valve 104 to drain the liquid water outside of the vehicle. If such drain functions are unavailable, the controller 102 may drain the liquid water to ambient via pump 106.

With continued reference to FIG. 1, in the example embodiment, the controller 102 is configured to optimize system power consumption by integrating control of the water spray on the radiator 92, the three-way control valve 60, FCS coolant pump 96, and electric fans 98. The controller 102 includes a predictive control strategy to change the state of the actuators (components above). In one example, controller 102 utilizes in-vehicle navigation system information to identify traffic patterns, vehicle speeds, and/or ambient temperatures along a planned route. This information is utilized in a predictive control algorithm to determine/estimate how much liquid product water will be produced and required for high performance operation. Fan power may be saved based on the water spray on the radiator 92, and water can be drained for forecasted freezing temperatures.

In the example embodiment, the controller 102 is configured to operate the fuel cell system 10 and/or thermal management system 12 in various operating modes. In a Start-Up Mode, the sensor 100 confirms if the separator 70 and/or the storage reservoir 76 is empty, partially full, or full. Control enables an economy Eco-Mode if the water level is greater than empty, and enables a Performance Mode if the water level is full. If the water level is partially full, control determines if there is a potential thermal power de-rate of fuel cell power.

In the Eco-Mode, control monitors FCS coolant temperature, ambient temperature, separator reservoir water level, and pump status (e.g., ON/OFF), and subsequently determines minimum total power values for fan RPM. If the reservoir water level is less than partially full, Eco-Mode is disabled and FCS cooling depends on the electric fan power usage and is subject to thermal de-rating of fuel cell power. When the water level reaches partially full, Eco-Mode is enabled and control supplies some water to the spray nozzles 90 while reserving a portion of water to increase the reservoir water level for a predicted high demand portion of the drive cycle. In this way, control sets a spray flow rate such that the reservoir water level reaches full within a predetermined amount of time (e.g., five minutes) following a vehicle start. When the water level meets or exceeds full, control increases the spray flow rate to a maximum rate or a rate that the FCS 14 is producing (product water) multiplied by a condenser effectiveness from the controller predictive thermal model. Additionally, a pump dry-run message on the CAN bus informs the controller 102 that a thermal de-rate condition could occur, and control increases fan RPM to maintain the coolant temperature target if additional fan RPM is available, or control indicates an impending thermal de-rate if additional fan RPM is not available.

In Performance Mode, depending on GPS map-based route planning data and ambient temperature, controller 102 sets the water pump 106 RPM to ensure spray water is available during the entire period of a high load fuel cell operating event. If the water level in the separator 70 and/or storage reservoir 76 reaches the partially full level, control reduces pump flow rate to a value based on a calculation of product water steady-state condensing performance based on the gross power level in the FCS 14, ambient temperature, and vehicle speed (for ram air cooling) or available condenser fan RPM. If the pump 106 signals a dry-run, then control sets a flag for thermal de-rating FCS gross power. In a Shut-Down Mode, controller 102 drains the reservoir/separator 70 and pump 106 if the ambient temperature is less than a predetermined threshold (e.g., 10° C.). If the ambient temperature is greater than the predetermined threshold, control does not drain the reservoir/separator 70.

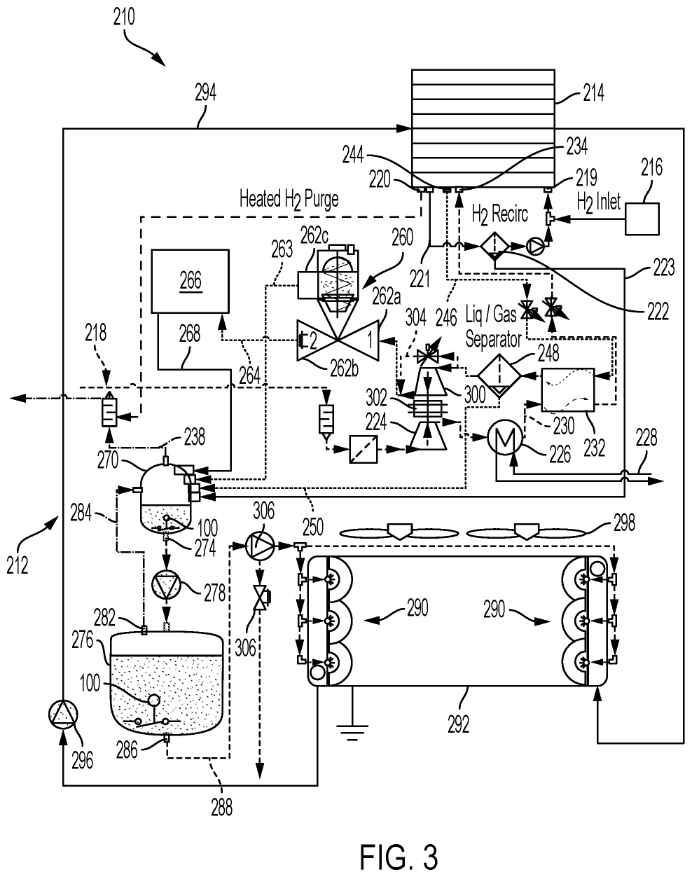

With reference now to FIG. 3, another example vehicle fuel cell system 210 with an associated thermal management system 212 is illustrated in accordance with the principles of the present disclosure. The vehicle fuel cell system 10 generally includes a fuel cell stack 214, a hydrogen fuel source 216, and an oxygen fuel source 218. In the example embodiment, the fuel cell stack 214 is a proton exchange membrane (PEM) fuel cell stack. However, it will be appreciated that thermal management system 212 may be utilized with various other types of fuel cell systems.

The hydrogen fuel source 216 is fluidly coupled to the fuel cell stack 214 at an inlet 219, and unused hydrogen fuel is directed through a purge outlet 220 or a recirculation line 221. Unused hydrogen is separated in a separator 222 and returned to inlet 219, while liquid product is directed via a conduit 223 to a pressurized, non-vented liquid-gas separator 270, which will be described herein in more detail.

The oxygen fuel source 218 is provided by an air compressor 224, which compresses ambient air. As described herein in more detail, the air compressor 224 is rotatably coupled to an expander 300, which is configured to power the air compressor 224 as well as generate electricity via an electric motor/generator 302 for energy recovery. The compressed and heated air is subsequently directed through a heat exchanger 226 for cooling thereof. In one embodiment, the heat exchanger 226 is fluidly coupled to a high temperature radiator coolant circuit 228. The cooled and compressed air is then directed through a conduit 230 to an external membrane humidifier 232 before entering the fuel cell stack 214 via an inlet 234.

Once in the fuel cell stack 14, the compressed air reacts with the hydrogen fuel, which generates electricity and water byproduct (water product). The water product and unused air are then directed through an outlet 244 and via a conduit 246 to the membrane humidifier 232 where water vapor from the exhaust gas is transferred to the compressed air supplied to inlet 234 to maintain an optimal hydration level of the electrolyte membrane. The water/air exhaust is then directed to a liquid-gas separator 248. Separated liquid is directed via conduit 250 to the liquid-gas separator 270. Separated air/vapor is directed through the expander 300 or an expander bypass line 304 to the integrated thermal management system 212.

In the example embodiment, the thermal management system 212 is configured to utilize the water/air exhaust from the fuel cell stack 214 to cool the fuel cell stack 214 and maintain an optimal temperature thereof. The thermal management system 212 includes a three-way valve 260, which in the example implementation, is a hybrid condenser bypass valve with an inlet port 262a, a first outlet port 262b, and a second outlet port 262c. The three-way valve 260 is configured to direct the received water/air exhaust either through a condenser bypass passage 263 to the liquid-gas separator 270, or through a conduit 264 to a condenser 266. The three-way valve 260 functions as a condenser bypass for vehicle operating conditions where the product water in the cathode exhaust stream could potentially freeze and block conduit 264. Operation of the three-way valve 260 is the same or similar to three-way valve 60, described above.

The condenser 266 is the same or similar to condenser 66 and may be one or more of the described three types. The water/air exhaust stream from conduit 264 is at least partially condensed in condenser 266 and subsequently directed via a conduit 268 to the liquid-gas separator 270. In the example embodiment, the separator 270 is configured to separate the gas and liquid received from the various illustrated inlets. The separated gas is directed to an exhaust line 238. The separator 270 also functions as a liquid reservoir and is configured to direct the separated liquid product water through a conduit 274 to a storage reservoir 276 (second reservoir). A pump 278 may be utilized to supply the liquid product water to an inlet 280 of the storage reservoir 276.

In the example embodiment, the storage reservoir 276 is configured to separate any gas and liquid received from conduit 274. The separated gas is directed through an outlet 282 to the separator 270 via a conduit 284. The storage reservoir 276 is configured to store the liquid product water for selective flow through a second outlet 286 to a supply conduit 288. A plurality of spray nozzles 290 are fluidly coupled to the supply conduit 288 and configured to selectively spray the product water onto a high-temperature radiator 292, which is thermally coupled to the fuel cell stack 214 for cooling thereof via a coolant circuit 294 and pump 296.

The product water sprayed onto the radiator 292 at least partially evaporates against the relatively hot radiator coolant, thereby increasing heat dissipation and reducing the radiator coolant temperature further than can be accomplished by air alone. The radiator 292 may be disposed between an A/C condenser (not shown) and one or more fans 298 to further improve evaporation, cooling, and airflow across the radiator 292.

In some embodiments, the separator 270 and storage reservoir 276 each include one sensor 100 to measure a liquid level in the reservoir. Sensors 100 are in signal communication with controller 102. Further, a drain valve 306 may be fluidly coupled to the supply conduit 288 and operate the in same or similar manner as drain valve 104. A pump 308 may be located on the supply conduit 288 to increase pressure and ensure adequate flow of product water from the storage reservoir 276 to the spray nozzles 290.

Described herein are systems and methods for thermal management of a fuel cell vehicle. The system directs water/air from the fuel cell stack exhaust to a condenser and subsequently to a water-gas separator pressure vessel followed by a liquid reservoir. The liquid water is selectively supplied to spray nozzles to direct the liquid water onto a high temperature radiator for increased cooling of the fuel cell stack.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A thermal management system for a vehicle having a fuel cell stack, the thermal management system comprising:
a condenser fluidly coupled to the fuel cell stack to receive a flow of water/air exhaust therefrom;
a liquid-gas separator fluidly coupled to the condenser to receive the flow of water/air exhaust therefrom, the liquid-gas separator including a first outlet to direct separated gas to an exhaust line, and a second outlet for separated liquid water;
a storage reservoir having an inlet to receive the separated liquid water from the second outlet of the liquid-gas separator, and a supply outlet for the liquid water;
one or more spray nozzles fluidly coupled to the storage reservoir supply outlet to receive a flow of liquid water therefrom; and
a coolant circuit configured to circulate a coolant to the fuel cell stack for cooling thereof, the coolant circuit including a radiator configured to cool the coolant,
wherein the one or more spray nozzles are configured to selectively spray the liquid water onto the radiator to increase cooling of the coolant and improve performance of the fuel cell stack.

2. The thermal management system of claim 1, further comprising a membrane humidifier configured to receive the flow of water/air exhaust from the fuel cell stack and humidify a flow of air into the fuel cell stack before supplying the water/air exhaust flow to the condenser.

3. The thermal management system of claim 1, further comprising a three-way valve disposed upstream of the condenser and configured to selectively direct the flow of water/air exhaust to the condenser or the exhaust line.

4. The thermal management system of claim 3, further comprising a back pressure control valve disposed upstream of the three-way valve.

5. The thermal management system of claim 3, further comprising a back pressure control valve disposed in the exhaust line downstream of the three-way valve.

6. The thermal management system of claim 1, further comprising a three-way valve disposed upstream of the condenser and configured to selectively direct the flow of water/air exhaust to the condenser or the separator.

7. The thermal management system of claim 6, further comprising an expander operably coupled to a compressor and an electric motor,
wherein the expander is configured to expand a gaseous portion of the water/air exhaust from the fuel cell stack upstream of the three-way valve,
wherein the compressor is configured to compress ambient air before supplying the compressed air to the fuel cell stack, and
wherein the electric motor is configured to generate electricity due to rotation of the expander.

8. The thermal management system of claim 1, wherein the liquid-gas separator is a pressurized accumulator vessel.

9. The thermal management system of claim 8, wherein the liquid-gas separator includes a first sensor configured to measure a liquid level in the liquid-gas separator, and
wherein the storage reservoir includes a second sensor configured to measure a liquid level in the storage reservoir.

10. The thermal management system of claim 9, further comprising:
a pump disposed between the storage reservoir supply outlet and the one or more spray nozzles; and
a controller in signal communication with the second sensor and the pump, the controller configured to control the flow of liquid water to the one or more spray nozzles based on the measured liquid level in the liquid-gas separator.

11. The thermal management system of claim 10, wherein when the measured liquid level meets or exceeds a predetermined full threshold, the controller commands the pump to provide a maximum flow rate to the one or more spray nozzles.

12. The thermal management system of claim 9, further comprising:
a pump disposed between the separator second outlet and the storage reservoir; and
a controller is signal communication with the first sensor and the pump, the controller configured to control the flow of liquid water to the storage reservoir based on the measure liquid level in the liquid-gas separator.

13. The thermal management system of claim 10, wherein the controller is configured to operate the thermal management system in a Performance Mode where, based on GPS map-based route planning data and ambient temperature, the controller sets an RPM of the pump to ensure liquid water is available to the one or more spray nozzles during a predicted high load fuel cell operating event.

14. The thermal management system of claim 10, wherein the controller is configured to operate the thermal management system in a Shut-Down Mode where the controller is configured to drain the liquid-gas separator and/or the storage reservoir if the ambient temperature is less than a predetermined threshold to thereby prevent freezing of the liquid water in the thermal management system.

15. The thermal management system of claim 10, wherein the controller is configured to operate the thermal management system in an Eco-Mode where, when the sensor indicates the storage reservoir is partially full, the controller is configured to supply liquid water to the one or more spray nozzles while reserving a portion of the liquid water to increase the water level in the storage reservoir for a predicted high-demand portion of a drive cycle.

16. The thermal management system of claim 1, wherein the condenser is a tube and fin heat exchanger with an electric fan configured to cool the water/air exhaust via heat exchange with ram air flow and/or airflow generated by the electric fan.

17. The thermal management system of claim 1, wherein the condenser is a tube heat exchanger configured to cool the water/air exhaust via heat exchange with ram air flow.

18. The thermal management system of claim 1, wherein the condenser is a liquid cooled heat exchanger thermally coupled to a second coolant circuit of the vehicle.

19. The thermal management system of claim 1, further comprising a drain valve disposed between the storage reservoir supply outlet and the one or more spray nozzles, the drain valve configured to drain liquid water from the thermal management system to prevent damage thereof.
